(19) United States
(12) Patent Application Publication
(10) Pub. No.: US 2026/0178463 A1
(43) Pub. Date: Jun. 25, 2026

(54) CLOUD DATA STORAGE OPTIMIZATION

(71) Applicant: PAYPAL, INC., San Jose, CA (US)

(72) Inventors: Sridivakar Inakonda, Bangalore (IN); Chandrasekar Venkatesan, Chennai (IN); Prakash Balasubramanian, Chennai (IN); Prasanna Krishna, Fremont, CA (US)

(21) Appl. No.: 19/044,184

(22) Filed: Feb. 3, 2025

(30) Foreign Application Priority Data
Dec. 19, 2024 (IN) 202441100777

(51) Int. Cl. G06F 11/34

(52) U.S. Cl. CPC G06F 11/3466; G06F 11/3409; G06F 11/3442

(57) ABSTRACT

Methods and systems are presented for providing a data storage optimization system. The data storage optimization system determines a data storage schema for storing data in one or more data storages. The data storage optimization system then monitors computer resources usage efficiency associated with accessing the data stored in the one or more data storages. When it is detected that the computer resources usage efficiency is below a threshold, the data storage optimization system determines modification recommendations for modifying the data storage schema. The data storage optimization system causes an implementation of the modification recommendations, and monitors the improvements to the computer resources usage efficiency.

### CROSS REFERENCE TO RELATED APPLICATION & PRIORITY CLAIM

The application claims priority to Indian Provisional Patent Application No. 202441100777, filed on Dec. 19, 2024, which is hereby incorporated by reference in its entirety as if fully set forth below and for all applicable purposes.

### BACKGROUND

The present specification generally relates to a cloud data storage optimization framework, and more specifically, to providing a framework that enables dynamic modifications to cloud data storage structures according to various embodiments of the disclosure.

### RELATED ART

Due to the large amount of data managed by organizations, it is common for much of the data to be stored on the cloud using one or more cloud data platforms. The data that is stored on the cloud for an organization may include data that is accessible by different users of the organization, such as internal users of the organization (e.g., employees of the organization, etc.), applications running on computers and providing services for the organization, and/or external users of the organization (e.g., customers of the organization, etc.). The data may be initially stored within one or more data structures (e.g., tables, data objects, data files, etc.) on the cloud. As the size of the data grows (e.g., new data being added by various users of the organization, etc.), querying of the data may become less efficient as more data structures are needed to be queried in order obtain all the data needed for more complex processing. However, since the data may be managed and/or accessed by different groups of users who may have different needs and priorities, it is a challenge for the organization to organize the storage of the data and to improve the efficiency of accessing the data. Thus, there is a need for an efficient computer framework for managing data storage for an organization in a centralized manner that address the needs of the different users within the organization and improve efficiency of querying the data.

### BRIEF DESCRIPTION OF THE FIGURES

FIG. 1 is a block diagram illustrating an electronic transaction system according to an embodiment of the present disclosure;

FIG. 2 is a block diagram illustrating a storage optimization module according to an embodiment of the present disclosure;

FIG. 3 is a flowchart showing a process of modifying one or more data structures for storing data according to an embodiment of the present disclosure;

FIG. 4 illustrates an example neural network that can be used to implement a machine learning model according to an embodiment of the present disclosure; and

FIG. 5 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a data storage optimization system. In some embodiments, the data storage optimization system is configured to monitor computer resources usage when data stored on one or more data storages (e.g., a cloud data storage, a local data storage, a cluster, etc.) is queried (e.g., accessed by one or more computer systems, etc.), to determine one or more modification recommendations to the data structures used to store the data, and to cause implementation of the modification recommendations to the data structures.

As discussed herein, data of an organization may be stored on one or more data storages according to a data storage schema. The data storage schema may specify one or more data structures (e.g., one or more tables, one or more data objects, one of more data files, one or more data blocks, etc.) for storing the data. For example, the data storage schema may specify a table that includes certain fields (e.g., user identifier, transaction identifier, a transaction amount, etc.), and at least a portion of the data corresponding to the certain fields may be stored within the table as different data records. In another example, the data storage schema may specify one or more data object definitions (e.g., the data type and data name included in each of the data objects, etc.), and at least a portion of the data may be stored in one or more data objects according to the one or more data object definitions. The data storage schema may also specify relationships between different data structures. For example, the data storage schema may specify a link between two data structures (e.g., a link between two tables, etc.), such that a data record from one data structure can be associated with a data record from another data structure. The data storage schema may also specify how the data is partitioned into different data structures. For example, the data storage schema may specify dividing at least a portion of the data into a number of partitions such that different partitions of the data are stored in separated data structures (e.g., stored in multiple tables, stored in multiple databases, etc.).

In some embodiments, the data storage optimization system determines the data storage schema (e.g., selecting and configuring the one or more data structures for storing the data in the one or more data storages, etc.) for storing the data based on various factors such as attributes of the data (e.g., an overall data size, an average size for each data record/data file, data types associated with the data, how static or dynamic the data is, etc.), the usage patterns of the different users of the organization (e.g., the types of data that are most frequently accessed/queried, the different types of data that are most frequently accessed/queried together, etc.), and/or other factors. As such, the data storage optimization system may analyze the data and the patterns of accessing the data, and determine the data storage schema for storing the data based on the analysis.

In some embodiments, the data storage optimization system determines the data storage schema with a goal to maximize a computer resources usage metric. The computer resources usage metric may be associated with a computer processor usage, a computer memory usage, a computer processing time, and/or other computer resources usage when querying any portion of the data of the organization stored in the one or more data storages. For example, when the data storage optimization system determines that two types of data are frequently accessed together (e.g., being accessed in the same query, etc.), the data storage optimization system may store data of these two types in the same data structure (e.g., in the same table, in the same data object, etc.) to improve the computer processor usage and memory usage efficiency when the data of these two types are being queried together. In another example, the data storage optimization system may partition at least a portion of the data when the size of the data exceeds a threshold size such that the computer processor usage and memory usage efficiency may be further improved.

After determining the data storage schema, the data storage optimization system may store the data in the one or more data storages according to the data storage schema. The way that the data is stored in the one or more data storages according to the data storage schema would provide high computer resources usage efficiency (e.g., exceeding a threshold, etc.) for querying any of the data from the one or more data storages. However, it has been contemplated that the data that is stored on the one or more data storages may grow and/or change over time. For example, new data may be added to the one or more data storages by different users of the organization and/or existing data on the one or more data storages may be removed by different users of the organization. As such, attributes of the data stored in the one or more data storages in the current state may be different from the attributes of the data that was initially stored on the one or more data storages. Furthermore, the usage patterns of the user of the organization may also change. For example, the frequency of accessing certain types of the data may change, the types of data that are being accessed together may change, etc.

Due to the changes in the attributes of the data and/or the usage patterns, the data storage schema that was determined for the data when the data was initially stored in the one or more data storage may no longer be optimized (e.g., providing maximum computer resources usage efficiency, providing computer resources usage efficiency above a threshold, etc.). As such, according to various embodiments of the disclosure, the data storage optimization system may monitor the computer resources usage for querying the data stored in the one or more data storages, and may dynamically modify the data storage schema for storing the data in the one or more data storages when the computer resource usage satisfies a set of criteria.

In some embodiments, the data storage optimization system obtains computer usage data from a data processing server that manages the data and processes data access functionalities for the data that is stored in the one or more data storages. For example, the data storage optimization system may provide instructions to the data processing server (e.g., via one or more application programming interface (API) calls, etc.) to log computer usage data (e.g., computer processor usage data, computer memory usage data, time data, etc.) and retrieve the computer usage data (e.g., periodically). The data storage optimization system may then determine if the computer usage data satisfies the set of criteria. The set of criteria may specify a threshold amount of computer processor usage for processing a query on the data, a threshold amount of computer memory usage for processing a query on the data, a threshold amount of time for processing a query on the data, etc. As such, the data storage optimization system may determine that the computer resource usage satisfies the set of criteria when the computer processor usage exceeds the threshold amount, the computer memory usage exceeds the threshold amount, and/or the time exceeds the threshold amount.

In some embodiments, when the data storage optimization system determines that the set of criteria is satisfied, the data storage optimization system may determine one or more modification recommendations for modifying the data storage schema. The modification recommendations may include restructuring of the one or more data structures or other components in which the data resides, such as splitting a data structure (e.g., dividing a table into multiple tables, etc.), re-partitioning at least a portion of the data, implementing a virtual machine for hosting the one or more data storages, resizing a virtual machine that stores the data, clustering the data, resizing/restructuring a cluster in which the data is stored, purging of unused data, moving data from a first tier of storage to a second tier of storage, removing duplicated data, and other modifications to the software and/or hardware components used to store the data.

In some embodiments, the data storage optimization system determines the one or more modification recommendations based on information obtained from different sources. For example, when the one or more data storages are cloud storages managed by a cloud service provider (e.g., GOOGLE CLOUD®, AMAZON WEB SERVICES®, etc.), the cloud service provider may provide one or more modification recommendations for improving the computer resources usage efficiency of accessing the data. In another example, when at least a portion of the data is accessed by one or more applications (e.g., GRANULATE®, Pure Storage®, IBM Turbonomic®, etc.) managed by one or more software service providers, the one or more software service providers may provide one or more modification recommendations for improving the computer resources usage efficiency of accessing the data.

One or more modification recommendations may also be generated internally within the organization. In some embodiments, the data storage optimization system provides a user interface that enables different users (e.g., different teams within the organization, etc.) to provide rule sets for triggering modification recommendations. A rule set may specify a condition (e.g., a size of the data exceeding a threshold size, a computer processor usage for querying a particular type of data exceeding a threshold, etc.), and one or more modification recommendations when the condition is detected. A rule set may also specify a restriction for modifying the data storage, such that even if a recommendation is obtained (e.g., generated by a cloud service provider, etc.), the storage optimization module 132 may determine not to implement such a recommendation based on the restriction provided by the user. The restriction may be associated with a particular data set (e.g., a restriction specifying that certain data cannot be moved from a data structure, a restriction specifying that certain duplicated data cannot be deleted, etc.), associated with a particular data structure (e.g., a restriction specifying a data structure cannot be modified, etc.), a particular data storage service (e.g., a restriction specifying that a certain data storage service cannot be used due to reliability issues, etc.), or other types of restrictions. As such, the data storage optimization system may monitor the condition of the data (e.g., the size of the data, the computer resources usages when the data is accessed, etc.), for example, based on retrieving and analyzing the computer usage data from the data processing server that manages the data and processes the data access functionalities associated with the data. When the data storage optimization system detects a condition based on a rule set, the data storage optimization system may generate one or more modification recommendations according to the rule set.

In some embodiments, the data storage optimization system also generates modification recommendations based on analyzing the computer usage data obtained from the data processing server. For example, when the data storage optimization system detects that two different data types from two different data structures are being accessed frequently together (e.g., exceeding a threshold frequency, etc.), the data storage optimization system may generate a modification recommendation for merging the two data structures, or modifying one of the data structures such that the two data types are being stored within the same data structure. In another example, when the data storage optimization system detects that the computer processing time for querying data from a particular data structure has exceeded a threshold time, the data storage optimization system may generate a modification recommendation for partitioning the data structure into multiple data structures.

The data storage optimization system may accumulate modification recommendations from the different sources. In some embodiments, the data storage optimization system may identify one or more internal teams corresponding to each of the modification recommendations, and may transmit the modification recommendations to the teams. For example, the data storage optimization system may present an alert on a device associated with a team that has been identified to be associated with a modification recommendation. The data storage optimization system may also provide a user interface on the device, to enable a team member of the team to modify or remove the recommendation.

In some embodiments, the data storage optimization system analyzes the different modification recommendations (e.g., recommendations that have not been removed by any of the team members, etc.), and causes the implementation of at least some of the modification recommendations. For example, the data storage optimization system may predict an effectiveness of each of the modification recommendations based on previous implementations of similar modifications. The data storage optimization system may then cause the implementations of modification recommendation(s) that are predicted to be effective (having an effectiveness above a threshold, etc.), and filter out modification recommendation(s) that are predicted to be ineffective (having an effectiveness below the threshold, etc.). In some embodiments, the data storage optimization system determines a score for each modification recommendation based on a predicted impact of the modification recommendation. For example, the data storage optimization system may use previously implemented modification(s) to predict, for each modification recommendation, an effectiveness of the modification recommendation based on a computer resources usage improvement and a cost (e.g., an amount of downtime for the data, etc.). In some embodiments, the data storage optimization system uses a machine learning model, that is trained with modification data associated with previously implemented modifications to the data structures used to store the data, to generate the effective score for each of the modification recommendations. The data storage optimization system may rank the modification recommendations based on the scores, and may cause implementations to one or more modification recommendations having the highest scores.

To implement a modification recommendation, the data storage optimization system may access the one or more data storages that store the data, and modify the one or more data structures according to the modification recommendation. However, the modification of the one or more data structures may cause a temporary restriction for accessing at least a portion of the data. Since the data is accessed by different users of the organization, before implementing the modification recommendation, the data storage optimization system may determine the users (e.g., the internal group(s) of the organization, etc.) that require access to the affected portion of the data, and may transmit a notification to each of the users that require access to the affected portion of the data. The notification may indicate the affected portion of the data. In some embodiments, the notification may also enable the users to access a user interface of the data storage optimization. Via the user interface, the users may specify requirements for implementing the modification recommendation, such as a timeline, suggested changes to the modification recommendation, etc. The data storage optimization system may then implement the modification recommendation based on the additional inputs provided by the users. If the modification recommendation specifies a clustering of the data, the data storage optimization system may create clusters in the one or more data storages, and may store the data in the clusters. If the modification recommendation specifies splitting of a table, the data storage optimization system may generate multiple tables based on attributes of the table (where each table may store a subset of the data types included in the original table), and store data from the original table in the newly generated tables.

In some embodiments, the data storage optimization system tracks the progress of the implementation of each modification recommendation. For example, the data storage optimization system may monitor the time it takes to implement each of the modification recommendations. After a modification recommendation is implemented, the data storage optimization system may also continue to monitor the computer resources usages of querying the data using the techniques disclosed herein, and determine an effectiveness of the modification recommendation based on comparing the computer resources usage of querying the data after the modification recommendation is implemented against the computer resources usage of querying the data before the modification recommendation is implemented. The effectiveness data for the newly implemented modification recommendation may be used by the data storage optimization system to retrain the machine learning model.

The data storage optimization system may continue to monitor the computer resource usages of querying the data stored on the one or more data storages, determine modifications that can improve the computer resource usage efficiency of querying the data, and implement the modifications, such that the efficiency performance of accessing the data can be maintained or improved over time. In some embodiments, if the data storage optimization system determines that the querying efficiency has not been improved by a threshold after the implementation of a modification, the data storage optimization system may rollback the implementation, for example, revert the data structure back to a state prior to the implementation of the modification recommendation.

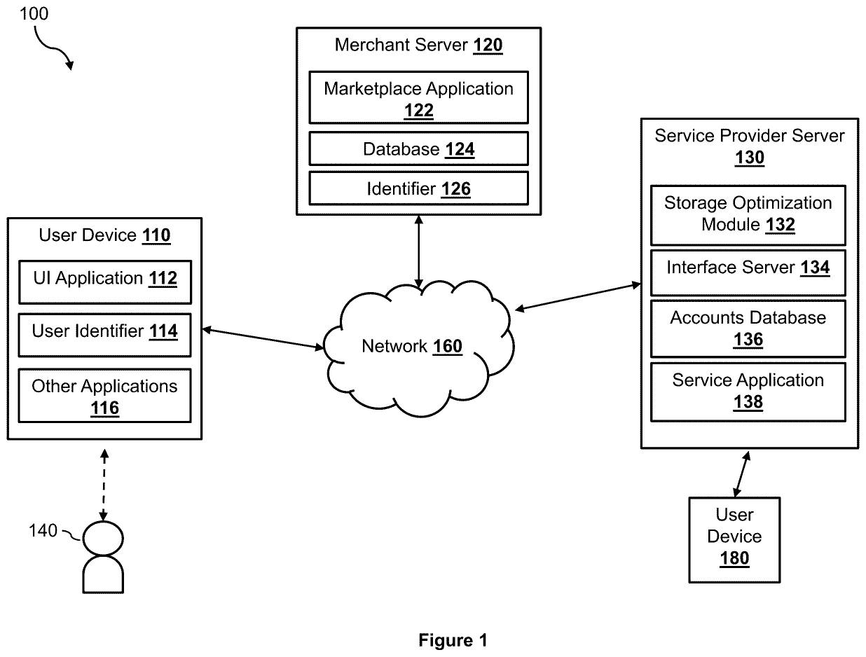

FIG. 1 illustrates an electronic transaction system 100, within which the data storage optimization system may be implemented according to one or more embodiments of the disclosure. The electronic transaction system 100 includes a service provider server 130, a merchant server 120, and user devices 110 and 180 that may be communicatively coupled with each other via a network 160. The network 160, in one embodiment, is implemented as a single network or a combination of multiple networks. For example, in various embodiments, the network 160 includes the Internet and/or one or more intranets, landline networks, wireless networks, and/or other appropriate types of communication networks. In another example, the network 160 comprises a wireless telecommunications network (e.g., cellular phone network) adapted to communicate with other communication networks, such as the Internet.

The user device 110, in one embodiment, is utilized by a user 140 to interact with the merchant server 120 and/or the service provider server 130 over the network 160. For example, the user 140 uses the user device 110 to conduct an online purchase transaction with the merchant server 120 via websites hosted by, or mobile applications associated with, the merchant server 120. The user 140 also logs in to a user account to access account services or conduct electronic transactions (e.g., data access, account transfers or payments, etc.) with the service provider server 130. The user device 110, in various embodiments, is implemented using any appropriate combination of hardware and/or software configured for wired and/or wireless communication over the network 160. In various implementations, the user device 110 includes at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to access data from and/or initiate electronic transactions with the merchant server 120 and/or the service provider server 130.

The user device 110, in various embodiments, includes other applications 116 as may be desired in one or more embodiments of the present disclosure to provide additional features available to the user 140. In one example, such other applications 116 include security applications for implementing client-side security features, programmatic client applications for interfacing with appropriate application programming interfaces (APIs) over the network 160, and/or various other types of generally known programs and/or software applications. In still other examples, the other applications 116 interface with the user interface application 112 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to access data stored in one or more cloud data storages, to conduct a purchase transaction with the merchant server 120 and/or the service provider server 130, to initiate a chargeback transaction request, etc.).

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items or services available for purchase in the merchant database 124. The merchant server 120, in one embodiment, includes at least one merchant identifier 126, which may be included as part of the one or more items or services made available for purchase so that, e.g., particular items and/or transactions are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110, the user device 180, and the service provider server 130 via the network 160.

The service provider server 130, in one embodiment, is maintained by a transaction processing entity or an online service provider, which provides processing of electronic transactions between users (e.g., the user 140 and users of other user devices, etc.) and/or between users and one or more merchants. As such, the service provider server 130 includes a service application 138, which may be adapted to interact with the user device 110, the user device 180, and/or the merchant server 120 over the network 160 to facilitate the electronic transactions (e.g., electronic payment transactions, data access transactions, etc.) among users and merchants processed by the service provider server 130. In one example, the service provider server 130 is provided by PayPal®, Inc., of San Jose, California, USA, and/or one or more service entities or a respective intermediary that provide multiple point of sale devices at various locations to facilitate transaction routings between merchants and, for example, service entities.

In some embodiments, the service application 138 includes a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 also includes an interface server 134 that is configured to serve content (e.g., web content) to users and interact with users. For example, the interface server 134 includes a web server configured to serve web content in response to HTTP requests. In another example, the interface server 134 includes an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 stores a log-in page and is configured to serve the log-in page to users for logging into user accounts of the users to access various data and/or services provided by the service provider server 130. The interface server 134 may also include other electronic pages associated with the different services (e.g., data access services, electronic transaction services, etc.) offered by the service provider server 130. As a result, a user (e.g., the user 140, the user of the user device 180, or a merchant associated with the merchant server 120, etc.) may access a user account associated with the user and access various data and/or services offered by the service provider server 130, by generating HTTP requests directed at the service provider server 130.

In one implementation, a user has identity attributes stored with the service provider server 130, and the user has credentials to authenticate or verify identity with the service provider server 130. User attributes may include personal information, banking information and/or funding sources. In various aspects, one or more of the user attributes are passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

The service provider server 130, in one embodiment, is configured to maintain data associated with one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information includes private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the data in the accounts database 136 (and/or any data in other database used by the system disclosed herein) may be implemented within the service provider server 130 or external to the service provider server 130 (e.g., implemented in a cloud, etc.).

The data associated with the service provider server 130 may be stored in one or more computer data storages, such as hard drives, solid-state storage devices, computer memories, etc., and is frequently accessed by different users and/or different computer software applications. For example, an external user of the service provider server 130 (e.g., the user 140, the merchant associated with the merchant server 120, etc.) may log in to a user account and access information associated with the user account. During the login process, an authentication software module may access user profile data associated with the user account to verify the authenticity of the user. An internal user of the service provider server 130 (e.g., the user of the user device 180, etc.) may access user data in the accounts database 136 to perform various data analysis functions. Each time a portion of the data is accessed (e.g., queried or otherwise retrieved using a computer application, etc.), computer processing resources are consumed. For example, computer processing resources (e.g., a number of central processing unit (CPU) cycles, etc.) may be required to perform the data retrieval functionality (e.g., locating the requested data in the one or more data storages, and obtaining the data, etc.), computer memory resources may be required to temporarily store data that includes the requested data (e.g., traversing a database may require storing various portions of the database in a computer memory and searching through the portions of the database in the computer memory, etc.), an amount of time may also be required to retrieve the requested data.

Since the data is frequently accessed (e.g., queried, etc.), it is beneficial for the service provider server 130 to store the data in a manner to optimize the computer resources usage efficiency when querying (or otherwise retrieving) the data from the data storages. As such, in various embodiments, the service provider server 130 also includes a storage optimization module 132 that implements the data storage optimization system as discussed herein. In some embodiments, the storage optimization module 132 determines a data storage schema for storing the data that provides more efficient computer resources usage when accessing any portions of the data. The data storage schema may specify different data structures for storing the data in the data storages. After storing the data in the data storages according to the data storage schema, the storage optimization module 132 may continue to monitor the computer resources usages when any portion of the data is accessed by one or more computer applications, and may dynamically implement modifications of the data storages scheme to continue to improve the computer resources usage efficiency for accessing the data.

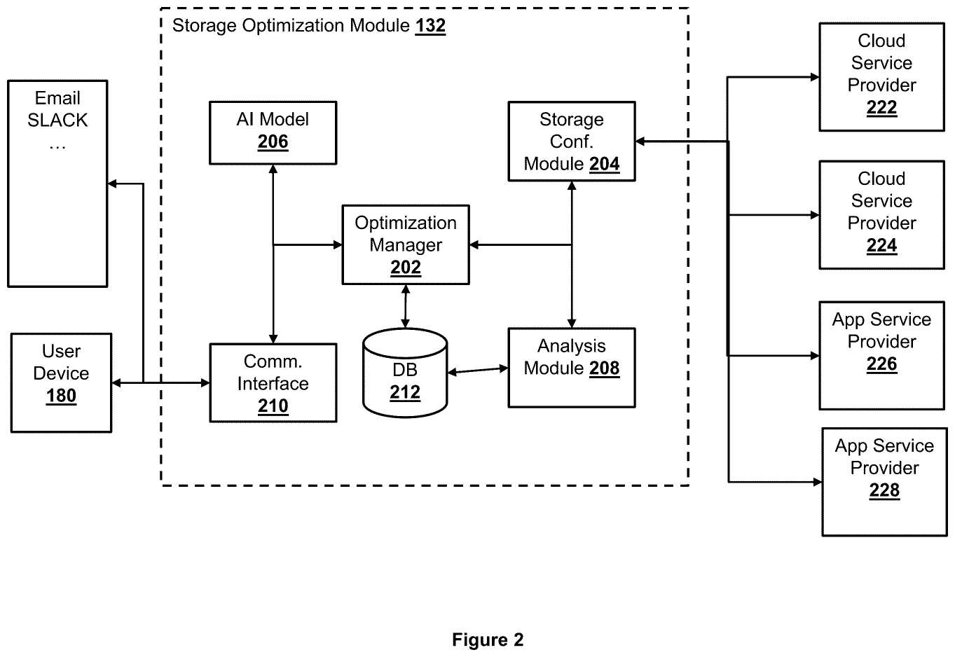

FIG. 2 illustrates a block diagram of the storage optimization module 132 according to an embodiment of the disclosure. The storage optimization module 132 includes an optimization manager 202, a storage configuration module 204, an artificial intelligence model 206, an analysis module 208, a communication interface 210, and a data storage 212. Since the data may be stored on one or more cloud data storages managed by one or more cloud service providers 222 and 224, the storage optimization module 132 may be communicatively coupled with cloud service providers 222 and 224. Furthermore, the service provider server 130 may use one or more third-party computer software applications for performing different functionalities (e.g., data analysis functionalities, human resources functionalities, payroll functionalities, etc.) for the service provider server 130, the storage optimization module 132 may also be communicatively coupled with application service providers 226 and 228.

In some embodiments, the storage optimization module 132 determines an initial data storage schema for storing the data associated with the service provider server 130 in one or more data storages (e.g., one or more cloud data storages managed by the cloud service providers 222 and 224, etc.). The initial data storage schema may specify one or more data structures (e.g., one or more tables, one or more data objects, one of more data files, etc.) for storing the data associated with the service provider server 130. For example, the data storage schema may specify a table that includes certain fields (e.g., user identifier, transaction identifier, a transaction amount, etc.), and at least a portion of the data corresponding to the certain fields may be stored within the table as different data records. In another example, the data storage schema may specify one or more data object definitions (e.g., the data type and data name included in each of the data objects, etc.), and at least a portion of the data may be stored in one or more data objects according to the one or more data object definitions. The data storage schema may also specify relationships between different data structures. For example, the data storage schema may specify a link between two data structures (e.g., a link between two tables, etc.), such that a data record from one data structure can be associated with a data record from another data structure. The data storage schema may also specify how the data is partitioned into different data structures. For example, the data storage schema may specify dividing at least a portion of the data into a number of partitions such that different partitions of the data are stored in separated data structures (e.g., stored in multiple tables, stored in multiple databases, etc.).

In some embodiments, the storage optimization module 132 determines the data storage schema for storing the data associated with the service provider server 130 based on various factors such as attributes of the data (e.g., an overall data size, an average size for each data record/data file, data types associated with the data, etc.), the usage patterns of the different users of the service provider server 130 (e.g., the types of data that are most frequently accessed/queried, the different types of data that are most frequently accessed/queried together, etc.), and/or other factors. As such, the optimization manager 202 may use the analysis module 208 to analyze the data and the patterns of accessing the data, and determine the data storage schema for storing the data based on the analysis.

In some embodiments, the storage optimization module 132 determines the data storage schema with a goal to maximize a computer resources usage metric. The computer resources usage metric may be associated with a computer processor usage, a computer memory usage, a computer processing time, and/or other computer resources usage when querying any portion of the data of the organization stored on the one or more data storages. For example, when the analysis module 208 determines that two types of data are frequently accessed together (e.g., being accessed in the same query, etc.), the storage optimization module 132 may determine to store data of these two types in the same data structure (e.g., in the same table, in the same data object, etc.) to improve the computer processor usage and memory usage efficiency when the data of these two types are being queried together. In another example, the storage optimization module 132 may determine to partition at least a portion of the data when the size of the data exceeds a threshold size such that the computer processor usage and memory usage efficiency may be further improved.

After determining the data storage schema, the storage optimization module 132 may store the data in the one or more data storages according to the data storage schema. For example, the optimization manager 202 may use the storage configuration module 204 to access the one or more data storages configured to store the data (e.g., via the cloud service providers 222 and 224, etc.). The storage configuration module 204 may then create the data structures specified in the data storage schema in the one or more data storages, and store the data in the data structures accordingly. The way that the data is stored in the one or more data storages according to the data storage schema would provide high computer resources usage efficiency (e.g., exceeding a threshold, etc.) for querying any of the data from the one or more data storages. However, it has been contemplated that the data that is stored on the one or more data storages may grow and/or change over time. For example, new data may be added to the one or more data storages by different users of the service provider server 130 and/or existing data on the one or more data storages may be removed by different users of the service provider server 130. As such, attributes of the data stored in the one or more data storages in a current state may be different from the attributes of the data that was initially stored in the one or more data storages. Furthermore, the usage patterns of the user of the service provider server 130 may also change. For example, the frequency of accessing certain types of the data may change, the types of data that are being accessed together may change, etc.

Due to the changes in the attributes of the data and/or the usage patterns, the data storage schema that was determined for the data when the data was initially stored on the one or more data storage may no longer be optimized (e.g., providing maximum computer resources usage efficiency, providing computer resources usage efficiency above a threshold, etc.). As such, the optimization manager 202 may monitor the computer resources usage for querying the data stored on the one or more data storages, and may dynamically modify the data storage schema for storing the data on the one or more data storages when the computer resource usage satisfies a set of criteria.

In some embodiments, the storage optimization module 132 obtains computer usage data from one or more devices that manages the data and/or processes data access functionalities for the data that is stored in the one or more data storages, such as the cloud service providers 222 and 224. For example, the optimization manager 202 may use the storage configuration module 204 to provide computer instructions to the devices (e.g., via one or more application programming interface (API) calls, etc.) to instruct the devices to log computer usage data (e.g., computer processor usage data, computer memory usage data, time data, etc.) and to retrieve the computer usage data (e.g., periodically). The optimization manager 202 may then use the analysis module 208 to determine if the computer usage data satisfies the set of criteria. The set of criteria may specify a threshold amount of computer processor usage for processing a query on the data, a threshold amount of computer memory usage for processing a query on the data, a threshold amount of time for processing a query on the data, etc. As such, the optimization manager 202 may determine that the computer resource usage satisfies the set of criteria when the computer processor usage exceeds the threshold amount, the computer memory usage exceeds the threshold amount, and/or the time exceeds the threshold amount.

In some embodiments, when the optimization manager 202 determines that the set of criteria is satisfied, the optimization manager 202 may determine one or more modification recommendations for modifying the data storage schema. The modification recommendations may include restructuring of the one or more data structures or other components in which the data resides, such as splitting a data structure (e.g., dividing a table into multiple tables, etc.), re-partitioning at least a portion of the data, implementing a virtual machine for hosting the one or more data storages, resizing a virtual machine that stores the data, clustering the data, resizing/restructuring a cluster in which the data is stored, and other modifications to the software and/or hardware components used to store the data.

In some embodiments, the optimization manager 202 determines the one or more modification recommendations based on information obtained from different sources. For example, when the one or more data storages are cloud storages managed by one or more cloud service providers (e.g., the cloud service providers 222 and 224, etc.), the cloud service providers 222 and/or 224 may provide one or more modification recommendations for improving the computer resources usage efficiency of accessing the data. In another example, when at least a portion of the data is accessed by one or more applications (e.g., for providing the services to the service provider server 130, etc.) managed by one or more software service providers (e.g., application service providers 226 and 228, etc.), the application service providers 226 and 228 may provide one or more modification recommendations for improving the computer resources usage efficiency of accessing the data.

One or more modification recommendations may also be generated internally by the storage optimization module 132 and/or the users of the service provider server 130. In some embodiments, the storage optimization module 132 provides a user interface that enables different users of the service provider server 130 (e.g., the user of the user device 180, etc.) to provide rule sets for triggering modification recommendations. A rule set may specify a condition (e.g., a size of the data exceeding a threshold size, a computer processor usage for querying a particular type of data exceeding a threshold, etc.), and one or more modification recommendation when the condition is detected. A rule set may also specify a restriction for modifying the data storage, such that even if a recommendation is obtained (e.g., generated by a cloud service provider, etc.), the storage optimization module 132 may determine not to implement such a recommendation based on the restriction provided by the user. The restriction may be associated with a particular data set (e.g., a restriction specifying that certain data cannot be moved from a data structure, a restriction specifying that certain duplicated data cannot be deleted, etc.), associated with a particular data structure (e.g., a restriction specifying a data structure cannot be modified, etc.), a particular data storage service (e.g., a restriction specifying that a certain data storage service cannot be used due to reliability issues, etc.), or other types of restrictions. As such, the optimization manager 202 may monitor the condition of the data (e.g., the size of the data, the computer resources usages when the data is accessed, etc.), for example, based on retrieving and analyzing the computer usage data from the cloud service providers 222 and 224 that manages the data and processes the data access functionalities associated with the data. The optimization manager 202 may store the computer usage data in the data storage 212, and the analysis module 208 may analyze the computer usage data stored in the data storage 212. When the optimization manager 202 detects a condition based on a rule set, the data storage optimization system may generate one or more modification recommendations according to the rule set.

In some embodiments, the storage optimization module 132 also generates modification recommendations based on analyzing the computer usage data obtained from the cloud service providers 222 and 224. For example, when the analysis module 208 detects that two different data types from two different data structures are being accessed frequently together (e.g., exceeding a threshold frequency, etc.), the optimization manager 202 may generate a modification recommendation for merging the two data structures, or modifying one of the data structures such that the two data types are being stored within the same data structure. In another example, when the analysis module 208 detects that the computer processing time for querying data from a particular data structure has exceeded a threshold time, the optimization manager 202 may generate a modification recommendation for partitioning the data structure into multiple data structures.

The optimization manager 202 may accumulate modification recommendations from the different sources. In some embodiments, the optimization manager 202 analyzes the different modification recommendations, and causes the implementation of at least some of the modification recommendations. For example, the optimization manager 202 may predict an effectiveness of each of the modification recommendations based on previous implementations of similar modifications. The optimization manager 202 may then cause the implementations of modification recommendation(s) that are predicted to be effective (having an effectiveness above a threshold, etc.), and filter out modification recommendation(s) that are predicted to be ineffective (having an effectiveness below the threshold, etc.). In some embodiments, the optimization manager 202 determines a score for each modification recommendation based on a predicted impact of the modification recommendation. For example, the optimization manager 202 may use previously implemented modification(s) to predict, for each modification recommendation, an effectiveness of the modification recommendation based on a computer resources usage improvement and a cost (e.g., an amount of downtime for the data, etc.). In some embodiments, the optimization manager 202 uses the artificial intelligence model 206 (e.g., a machine learning model such as an artificial neural network, etc.), that is trained with modification data associated with previously implemented modifications to the data structures used to store the data, to generate the effective score for each of the modification recommendations. The optimization manager 202 may rank the modification recommendations based on the scores, and may cause implementations to one or more modification recommendations having the highest scores.

To implement a modification recommendation, the optimization manager 202 may use the storage configuration module 204 to access the one or more data storages that store the data, and modify the one or more data structures according to the modification recommendation. However, the modification of the one or more data structures may cause a temporary restriction for accessing at least a portion of the data. Since the data is accessed by different users of the service provider server 130, before implementing the modification recommendation, the optimization manager 202 may determine the users that require access to the affected portion of the data, and may transmit a notification to each of the users that require access to the affected portion of the data. For example, the optimization manager 202 may use the communication interface 210 to transmit notifications to devices of the different users who need to access the affected data. The notification may be transmitted via different communication channels, such as emails, chat services, push notifications via applications of the devices, etc.

The notification may indicate the affected portion of the data. In some embodiments, the notification may also enable the users to access a user interface provided by the storage optimization module 132. Via the user interface, the users may specify requirements for implementing the modification recommendation, such as a timeline, suggested changes to the modification recommendation, etc. The storage optimization module 132 may then implement the modification recommendation based on the additional inputs provided by the users. If the modification recommendation specifies a clustering of the data, the optimization manager 202 may use the storage configuration module 204 to create clusters in the one or more data storages, and may store the data in the clusters. If the modification recommendation specifies splitting of a table, the optimization manager 202 may use the storage configuration module 204 to generate multiple tables based on attributes of the table (where each table may store a subset of the data types included in the original table), and store data from the original table in the newly generated tables.

In some embodiments, the optimization manager 202 tracks the progress of the implementation of each modification recommendation. For example, the optimization manager 202 may monitor the time it takes to implement each of the modification recommendations. After a modification recommendation is implemented, the optimization manager 202 may also continue to monitor the computer resources usage of querying the data using the techniques disclosed herein, and determine an effectiveness of the modification recommendation based on comparing the computer resources usage of querying the data after the modification recommendation is implemented against the computer resources usage of querying the data before the modification recommendation is implemented. The effectiveness data for the newly implemented modification recommendation may be used by the optimization manager 202 to retrain the artificial intelligence model 206.

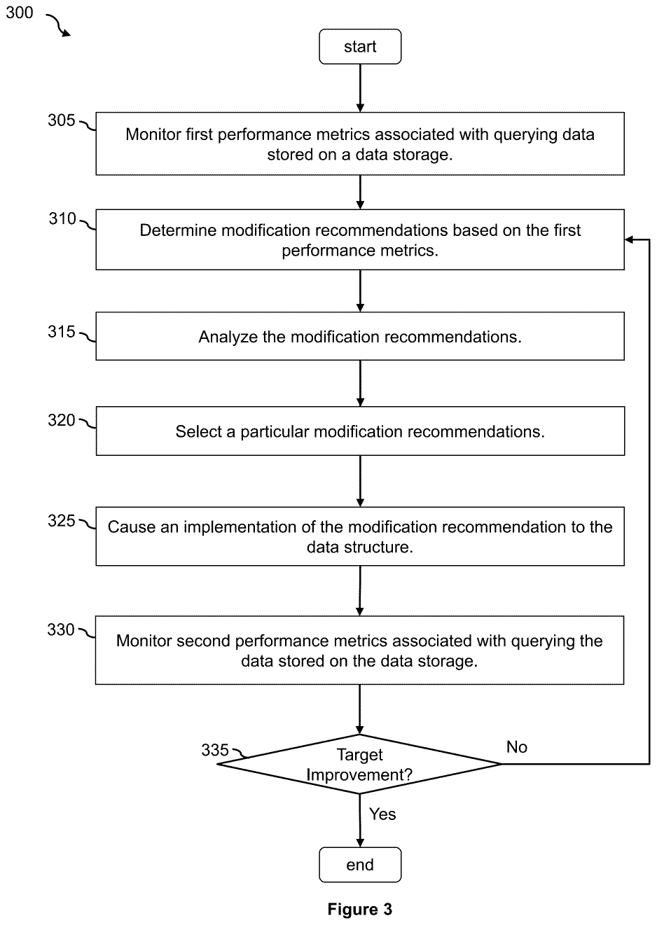

FIG. 3 illustrates a process 300 for dynamically improving computer resources usage efficiency for querying data according to various embodiments of the disclosure. In some embodiments, at least a portion of the process 300 is performed by the storage optimization module 132, although one or more steps may be performed by one or more of the components/devices/modules/systems described herein. The process 300 begins by monitoring (at step 305) first performance metrics associated with querying data stored on a data storage. For example, the optimization manager 202 may instruct the cloud service providers 222 and 224 to log computer usage data, and provide the computer usage data to the storage optimization module 132. The computer usage data may include a computer processor usage (e.g., a number of CPU cycles), memory usage, and/or a time required to process one or more queries for retrieving data from the data storage.

The optimization manager 202 then determines (at step 310) modification recommendations based on the first performance metrics. In some embodiments, the optimization manager 202 obtains modification recommendations from different sources, such as the cloud service providers 222 and 224 that manage the data stored on the data storage and provides data access functionalities for the data, the application service providers 226 and 228 that host computer software applications that provide services to the service provider server 130 by accessing the data stored on the data storage, internal users of the service provider server 130, and modification recommendations generated by the storage optimization module 132 based on analyzing computer usage data associated with querying the data from the data storage.

The optimization manager 202 then analyzes (at step 315) the modification recommendations. For example, the optimization manager 202 may use the analysis module 208 predict an effectiveness of each modification recommendation based on analyzing similar modifications that have been implemented in the past. The optimization manager 202 may also use the artificial intelligence model 206 to generate an effective score for each modification recommendation. The artificial intelligence model 206 may be configured to accept attributes of a modification recommendation (e.g., a type of modification, an amount of the data that will be affected, data types involved in the modification, etc.), and produce an effectiveness score representing an improvement to the computer resources usage and a cost (e.g., a downtime for accessing the data, etc.). In some embodiments, step 310 and/or step 315 also uses predicted usage or access of data to determine and/or analyze modification recommendations. The predictions can be based on an upcoming event, time of year, or other data that may result in a decrease or an increase in expected data access by the system.

In some embodiments, the optimization manager 202 ranks the modification recommendations based on the effectiveness scores. The optimization manager 202 then selects (at step 320) a particular modification recommendation and causes (at step 325) an implementation of the modification recommendation to the data structure. For example, the optimization manager 202 may select the particular modification recommendation based on the effectiveness score and/or the ranking. The optimization manager 202 may implement (or instruct another computer device to implement) the modification recommendation such that the data structure is modified according to the modification recommendation.

The optimization manager 202 then monitors (at step 330) second performance metrics associated with querying the data stored on the data storage. For example, after implementing the modification recommendation, the optimization manager 202 may continue to track the computer usage performance of querying the data from the data storage. The optimization manager 202 determines (at step 335) whether the improvement provided by the modification meets a target improvement. If it is determined that the improvement does not meet the target improvement, the optimization manager 202 may determine another modification recommendation to implement (e.g., repeating steps 310, 315, 320, 325, and 330). Alternatively, if it is determined that the improvement does not meet the target improvement, the optimization manager 202 may rollback the implementation, for example, revert the data structure back to a state prior to the implementation of the modification recommendation.

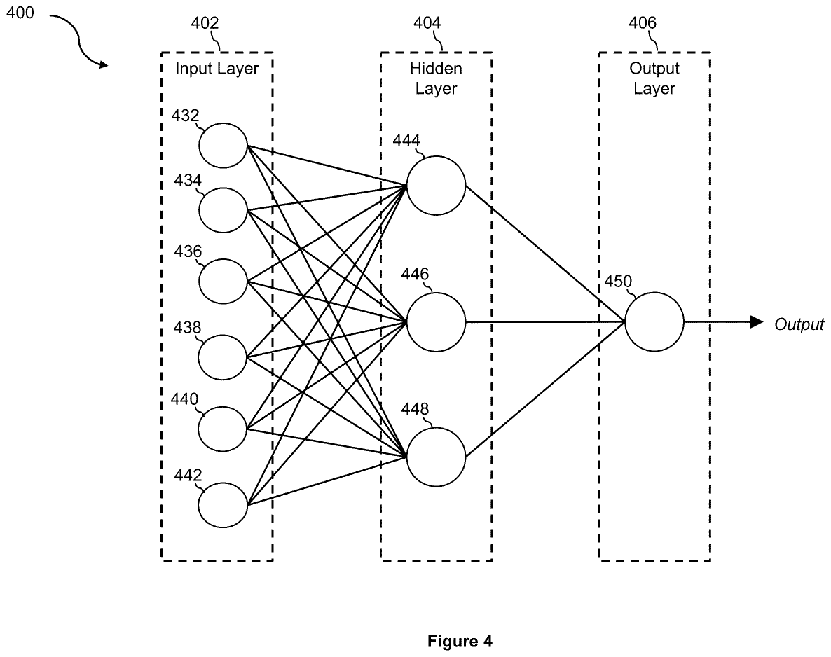

FIG. 4 illustrates an example artificial neural network 400 that may be used to implement a machine learning model, such as the artificial intelligence model 206. As shown, the artificial neural network 400 includes three layers—an input layer 402, a hidden layer 404, and an output layer 406. Each of the layers 402, 404, and 406 may include one or more nodes (also referred to as “neurons”). For example, the input layer 402 includes nodes 432, 434, 436, 438, 440, and 442, the hidden layer 404 includes nodes 444, 446, and 448, and the output layer 406 includes a node 450. In this example, each node in a layer is connected to every node in an adjacent layer via edges and an adjustable weight is often associated with each edge. For example, the node 432 in the input layer 402 is connected to all of the nodes 444, 446, and 448 in the hidden layer 404. Similarly, the node 444 in the hidden layer is connected to all of the nodes 432, 434, 436, 438, 440, and 442 in the input layer 402 and the node 450 in the output layer 406. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 404 is an intermediate layer between the input layer 402 and the output layer 406 of the artificial neural network 400. Although only one hidden layer is shown for the artificial neural network 400 for illustrative purpose only, it has been contemplated that the artificial neural network 400 used to implement any one of the computer-based models may include as many hidden layers as necessary. The hidden layer 404 is configured to extract and transform the input data received from the input layer 402 through a series of weighted computations and activation functions.

In this example, the artificial neural network 400 receives a set of inputs and produces an output. Each node in the input layer 402 may correspond to a distinct input. For example, when the artificial neural network 400 is used to implement the artificial intelligence model 206, the nodes in the input layer 402 may correspond to different attributes associated with a modification recommendation.

In some embodiments, each of the nodes 444, 446, and 448 in the hidden layer 404 generates a representation, which may include a mathematical computation (or algorithm) that produces a value based on the input values received from the nodes 432, 434, 436, 438, 440, and 442. The mathematical computation may include assigning different weights (e.g., node weights, edge weights, etc.) to each of the data values received from the nodes 432, 434, 436, 438, 440, and 442, performing a weighted sum of the inputs according to the weights assigned to each connection (e.g., each edge), and then applying an activation function associated with the respective node (or neuron) to the result. The nodes 444, 446, and 448 may include different algorithms (e.g., different activation functions) and/or different weights assigned to the data variables from the nodes 432, 434, 436, 438, 440, and 442 such that each of the nodes 444, 446, and 448 may produce a different value based on the same input values received from the nodes 432, 434, 436, 438, 440, and 442. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 402 is transformed into rather different values indicative data characteristics corresponding to a task that the artificial neural network 400 has been designed to perform.

In some embodiments, the weights that are initially assigned to the input values for each of the nodes 444, 446, and 448 may be randomly generated (e.g., using a computer randomizer). The values generated by the nodes 444, 446, and 448 may be used by the node 450 in the output layer 406 to produce an output value (e.g., a response to a user query, a prediction, etc.) for the artificial neural network 400. The number of nodes in the output layer depends on the nature of the task being addressed. For example, in a binary classification problem, the output layer may consist of a single node representing the probability of belonging to one class (as in the example shown in FIG. 4). In a multi-class classification problem, the output layer may have multiple nodes, each representing the probability of belonging to a specific class. When the artificial neural network 400 is used to implement the artificial intelligence model 206, the output node 750 may be configured to generate an effective score representing an effectiveness of a modification recommendation.

In some embodiments, the artificial neural network 400 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 400 may be trained by using training data based on one or more loss functions and one or more hyperparameters. By using the training data to iteratively train the artificial neural network 400 through a feedback mechanism (e.g., comparing an output from the artificial neural network 400 against an expected output, which is also known as the “ground-truth” or “label”), the parameters (e.g., the weights, bias parameters, coefficients in the activation functions, etc.) of the artificial neural network 400 may be adjusted to achieve an objective according to the one or more loss functions and based on the one or more hyperparameters such that an optimal output is produced in the output layer 406 to minimize the loss in the loss functions. Given the loss, the negative gradient of the loss function is computed with respect to each weight of each layer individually. Such negative gradient is computed one layer at a time, iteratively backward from the last layer (e.g., the output layer 406 to the input layer 402 of the artificial neural network 400). These gradients quantify the sensitivity of the network's output to changes in the parameters. The chain rule of calculus is applied to efficiently calculate these gradients by propagating the gradients backward from the output layer 406 to the input layer 402.

Parameters of the artificial neural network 400 are updated backwardly from the last layer to the input layer (backpropagating) based on the computed negative gradient using an optimization algorithm to minimize the loss. The backpropagation from the last layer (e.g., the output layer 406) to the input layer 402 may be conducted for a number of training samples in a number of iterative training epochs. In this way, parameters of the artificial neural network 400 may be gradually updated in a direction to result in a lesser or minimized loss, indicating the artificial neural network 400 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

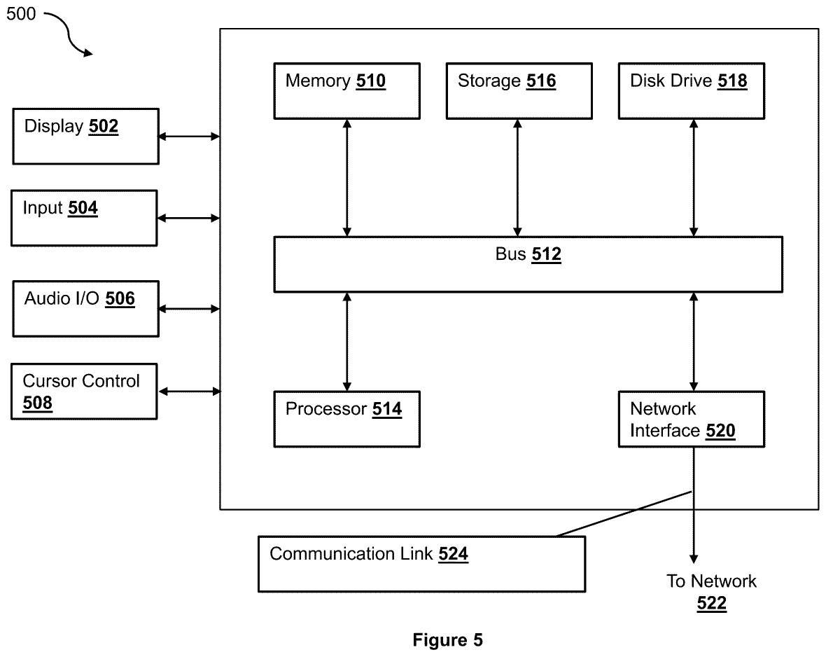

FIG. 5 is a block diagram of a computer system 500 suitable for implementing one or more embodiments of the present disclosure, including the service provider server 130, the merchant server 120, the user device 180, the user device 110, the cloud service providers 222 and 224, and the application service providers 226 and 228. In various implementations, each of the user devices 110 and 180 may include a mobile cellular phone, personal computer (PC), laptop, wearable computing device, etc. adapted for wireless communication, and each of the service provider server 130, the merchant server 120, the cloud service providers 222 and 224, and the application service providers 226 and 228 may include a network computing device, such as a server. Thus, it should be appreciated that the devices 110, 120, 130, 180, 222, 224, 226, and 228 may be implemented as the computer system 500 in a manner as follows.

The computer system 500 includes a bus 512 or other communication mechanism for communicating information data, signals, and information between various components of the computer system 500. The components include an input/output (I/O) component 504 that processes a user (i.e., sender, recipient, service provider) action, such as selecting keys from a keypad/keyboard, selecting one or more buttons or links, etc., and sends a corresponding signal to the bus 512. The I/O component 504 may also include an output component, such as a display 502 and a cursor control 508 (such as a keyboard, keypad, mouse, etc.). The display 502 may be configured to present a login page for logging into a user account or a checkout page for purchasing an item from a merchant. An optional audio input/output component 506 may also be included to allow a user to use voice for inputting information by converting audio signals. The audio I/O component 506 may allow the user to hear audio. A transceiver or network interface 520 transmits and receives signals between the computer system 500 and other devices, such as another user device, a merchant server, or a service provider server via a network 522. In one embodiment, the transmission is wireless, although other transmission mediums and methods may also be suitable. A processor 514, which can be a micro-controller, digital signal processor (DSP), or other processing component, processes these various signals, such as for display on the computer system 500 or transmission to other devices via a communication link 524. The processor 514 may also control transmission of information, such as cookies or IP addresses, to other devices.

The components of the computer system 500 also include a system memory component 510 (e.g., RAM), a static storage component 516 (e.g., ROM), and/or a disk drive 518 (e.g., a solid-state drive, a hard drive). The computer system 500 performs specific operations by the processor 514 and other components by executing one or more sequences of instructions contained in the system memory component 510. For example, the processor 514 can perform the data structure modification functionalities described herein, for example, according to the process 300.

Logic may be encoded in a computer readable medium, which may refer to any medium that participates in providing instructions to the processor 514 for execution. Such a medium may take many forms, including but not limited to, non-volatile media, volatile media, and transmission media. In various implementations, non-volatile media includes optical or magnetic disks, volatile media includes dynamic memory, such as the system memory component 510, and transmission media includes coaxial cables, copper wire, and fiber optics, including wires that comprise the bus 512. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
monitor first performance metrics associated with querying data stored on one or more cloud servers over a first time period, wherein the data is stored in a data structure;
determine, using a machine learning model, a modification to the data structure based on the first performance metrics, wherein the modification is determined to improve a computer processing usage efficiency of querying the data; and
cause an implementation of the modification to the data structure.

2. The system of claim 1, wherein executing the instructions further cause the system to: subsequent to causing the implementation of the modification to the data structure, monitor second performance metrics associated with querying the data stored on the one or more cloud servers over a second time period.

3. The system of claim 2, wherein executing the instructions further causes the system to:
compare the second performance metrics against the first performance metrics; and
train the machine learning model based on the comparing.

4. The system of claim 3, wherein executing the instructions further causes the system to:
determine, using the trained machine learning model, to further modify the modified data structure for storing the data based on the comparing.

5. The system of claim 1, wherein causing the implementation of the modification to the data structure comprises:
partitioning at least a portion of the data stored in the data structure.

6. The system of claim 1, wherein causing the implementation of the modification to the data structure comprises:
clustering at least a portion of the data stored in the data structure.

7. The system of claim 1, wherein the data structure comprises a table, and wherein causing the implementation of the modification to the data structure comprises:
splitting the table into a plurality of tables.

8. A method comprising:
determining, by a computer system, computer resources usage data associated with accessing one or more datasets from a plurality of datasets stored on one or more data storages, wherein the plurality of datasets is stored according to one or more data structures;
in response to determining that the computer resources usage data exceeds a threshold, determining a modification to the one or more data structures, wherein the modification improves a computer resources usage efficiency of accessing the plurality of datasets from the one or more data storages; and
causing, by the computer system, an implementation of the modification to the one or more data structures.

9. The method of claim 8, wherein the modification comprises at least one of a re-partitioning of at least a portion of the plurality of datasets, a clustering of the at least the portion of the plurality of datasets, or splitting the one or more data structures.

10. The method of claim 8, wherein the one or more data structures comprises a plurality of tables that store different portions of the plurality of datasets.

11. The method of claim 8, wherein the plurality of datasets is stored in a cluster.

12. The method of claim 8, wherein the computer resources usage data represents at least one of a computer processor usage for processing a query, a computer memory usage for processing the query, or a time for processing the query.

13. The method of claim 1, further comprising:
obtaining a plurality of modification recommendations from a plurality of sources based on the computer resources usage data; and
selecting, from the plurality of modification recommendations, a particular modification recommendation based on analyzing the plurality of modification recommendations, wherein the causing the implementation of the modification to the data structure is based on the particular modification recommendation.

14. The system of claim 13, wherein the selecting the particular modification recommendation is further based on at least one of an estimated downtime of a data querying service for each of the plurality of modification recommendations or an estimated performance improvement for each of the plurality of modification recommendations.

15. A non-transitory machine-readable medium having stored thereon machine-readable instructions executable to cause a machine to perform operations comprising:
determining computer resources usage data associated with accessing datasets stored on one or more data storages, wherein the datasets are stored according to one or more data structures;
determining that the first computer resources usage data exceeds a threshold;
determining, using a machine learning model, a modification to the one or more data structures, wherein the modification is predicted to improve a computer resources usage efficiency of accessing the datasets from the one or more data storages; and
causing an implementation of the modification to the one or more data structures.

16. The non-transitory machine-readable medium of claim 15, wherein the operations further comprise:
tracking a progress of the implementation of the modification to the one or more data structures.

17. The non-transitory machine-readable medium of claim 15, wherein the computer resources usage data is first computer resources usage data, and wherein the operations further comprise: subsequent to the causing the implementation of the modification to the one or more data structures, determining second computer resources usages data associated with accessing the datasets stored on the one or more data storages.

18. The non-transitory machine-readable medium of claim 17, wherein the operations further comprise:
comparing the second computer resources usage data against the first computer resources usage data; and
training the machine learning model based on the comparing.

19. The non-transitory machine-readable medium of claim 18, wherein the operations further comprise:
determining, using the trained machine learning model, to further modify the modified one or more data structures for storing the datasets based on the comparing.

20. The non-transitory machine-readable medium of claim 15, wherein the causing the implementation of the modification to the data structure comprises:
resizing a virtual machine configured to host the one or more data storages.
